(19) United States
(12) Patent Application Publication
(10) Pub. No.: US 2015/0302721 A1
(43) Pub. Date: Oct. 22, 2015

(54) Crib Having Child Monitoring System

(71) Applicant: Stephanie Schmidt, Oak Run, CA (US)

(72) Inventor: Stephanie Schmidt, Oak Run, CA (US)

(21) Appl. No.: 14/686,091

(22) Filed: Apr. 14, 2015

Related U.S. Application Data
(60) Provisional application No. 61/981,502, filed on Apr. 18, 2014.

(51) Int. Cl. G08B 21/04; G08B 21/02; G01G 19/44; A47D 9/00; A47D 15/00

(52) U.S. Cl. CPC G08B 21/0461; A47D 9/00; A47D 15/00; G01G 19/445; G08B 21/0208

(57) ABSTRACT

A crib having a child monitoring system. The crib comprises a frame and a base member that can be positioned at various heights on the frame. Further, the crib includes monitoring devices for monitoring a child within the crib. The monitoring devices may include a video camera, a weight sensor for determining if the child is positioned within the crib, and a breathing monitor. The crib may also include an audio system with one or more speakers for playing music or soothing sounds, and may further include a nightlight controlled by a motion sensor. A user input device, such as a touchscreen display is provided for operating the various features of the crib, wherein the input device is positioned on the crib frame. A docking station is also provided that is in wireless communication with the child monitoring system, wherein the docking station can receive a mobile electronic device therein.

### CROSS REFERENCE TO RELATED APPLICATION

This application claims the benefit of U.S. Provisional Application No. 61/981,502 filed on Apr. 18, 2014. The above identified patent application is herein incorporated by reference in its entirety to provide continuity of disclosure.

### BACKGROUND OF THE INVENTION

### Field of the Invention

The present invention relates to cribs having infant monitoring features. More specifically, the present invention provides an infant monitoring system integrated into a crib, wherein the crib includes a video camera for monitoring an infant, a weight sensor for detecting if the child is in the crib, a breathing monitor, and one or more speakers for playing music or soothing sounds, wherein the system can be controlled via a touchscreen on the crib or via a docking station and a user's mobile electronic device.

It is important to constantly monitor and supervise infants to ensure their health and safety. Infants can suffocate or suffer from sudden infant death syndrome (SIDS) even while safely positioned within a crib. As a result, the caretakers must continually check on the infant and maintain watch over the infant to ensure that the infant is safely positioned within the crib and to ensure that the infant is breathing. While cribs may be constructed so as to minimize or prevent the likelihood of the infant being injured or harmed while in the crib, the caretakers must still check on the infant regularly.

While it is important for caretakers to continuously monitor an infant, as a practical matter the caretakers cannot remain with the child throughout the entirety of each day. Caretakers often have to leave the child unsupervised for brief periods in order to prepare meals, use the restroom, shop for groceries and supplies, or to sleep. Many caretakers take turns monitoring the infant or hire nannies or others to watch over the child, but this can be prohibitively expensive for some caretakers. Further, the caretaker may worry or become nervous while away from the child, and the caretaker may desire a way to check in on the child while away from home. Thus, a system for allowing a user to monitor their infant while away from the crib is desired.

Devices have been disclosed in the prior art that relate to infant monitoring devices. These include devices that have been patented and published in patent application publications. Some patents and publications provide devices for stimulating an infant, such as U.S. Published Patent Number 2011/0137217. Other patents relate to devices for monitoring the movements of an infant, such as U.S. Pat. No. 5,505,199 and U.S. Pat. No. 6,492,634. U.S. Pat. No. 5,400,012 provides a breathing monitor for an infant. Further, U.S. Published Patent Application Number 2010/0245091 provides a physiology monitoring device for monitoring the hearts and lungs of a patient.

These prior art devices have several known drawbacks. These devices fail to provide a crib having one or more child monitoring devices integrated therein, wherein the user can remotely monitor a child via his or her mobile device and can remotely operate the child monitoring system. Such devices further fail to disclose additional features such as a motion-sensing nightlight and an audio system for playing music for the child.

In light of the devices disclosed in the prior art, it is submitted that the present invention substantially diverges in design elements from the prior art and consequently it is clear that there is a need in the art for an improvement to existing child monitoring systems. In this regard the instant invention substantially fulfills these needs.

### SUMMARY OF THE INVENTION

In view of the foregoing disadvantages inherent in the known types of child monitoring systems now present in the prior art, the present invention provides a new crib having a child monitoring system wherein the same can be utilized for providing convenience for the user when monitoring an infant within a crib.

It is therefore an object of the present invention to provide a new and improved crib having a child monitoring system that has all of the advantages of the prior art and none of the disadvantages.

It is another object of the present invention to provide a crib having a child monitoring system comprising a crib with one or more child monitoring sensors or devices integrated therein, such as a video camera, a breathing monitor, and a weight sensor.

Another object of the present invention is to provide a crib having a child monitoring system that is operated via a touchscreen display positioned on a crib.

Yet another object of the present invention is to provide a crib having a child monitoring system that is operated remotely via the user's mobile electronic device, such as the user's smartphone.

Another object of the present invention is to provide a crib having a child monitoring system having one or more nightlights thereon, wherein the nightlights are operably connected to motion sensors such that the nightlights illuminate or increase in brightness as motion is detected.

A further object of the present invention is to provide a crib having a child monitoring system wherein the front rail of the crib can be interchanged between a full size crib rail, or a shortened guard rail to provide easier access to the interior of the crib.

An additional object of the present invention is to provide a crib having a child monitoring system wherein the base of the crib can be positioned at various heights on the crib frame by securing tabs on the base member with different apertures on the crib frame.

Another object of the present invention is to provide a crib having a child monitoring system that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the crib of the present invention.

FIG. 2 shows a perspective view of the base member as positioned for securement to the crib frame.

FIG. 3 shows a perspective view of the crib having a low guard rail.

FIG. 4 shows a perspective view of an embodiment of the docking station of the present invention.

FIG. 5 shows a schematic diagram of the child monitoring system of the present invention.

### DETAILED DESCRIPTION OF THE INVENTION

Reference is made herein to the attached drawings. Like reference numerals are used throughout the drawings to depict like or similar elements of the child monitoring system. For the purposes of presenting a brief and clear description of the present invention, the preferred embodiment will be discussed as used for remotely monitoring an infant within a crib. The figures are intended for representative purposes only and should not be considered to be limiting in any respect.

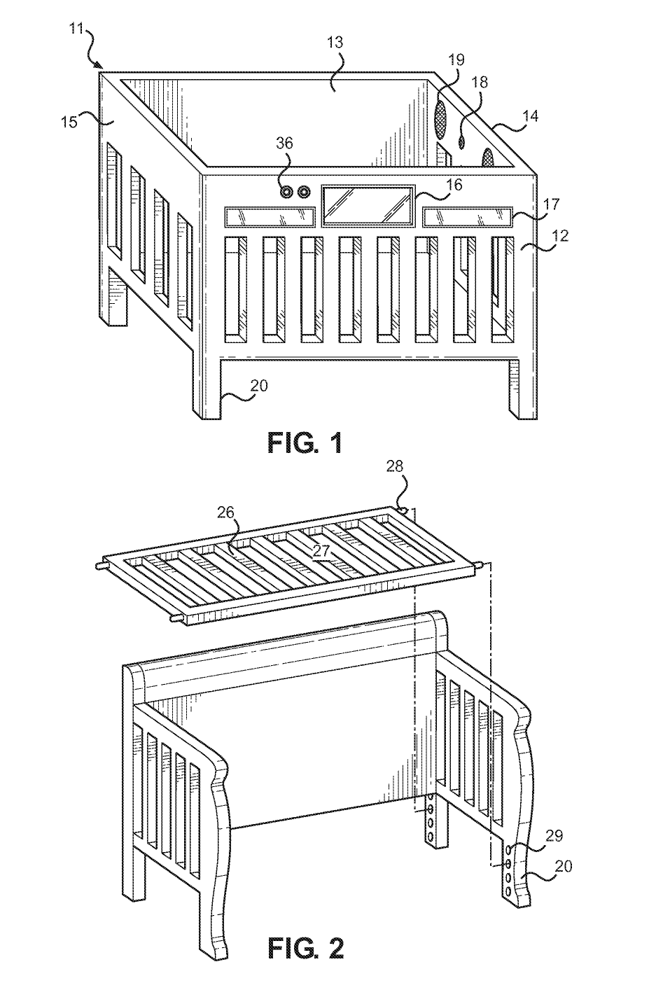

Referring now to FIG. 1, there is shown a perspective view of an embodiment of the crib of the present invention. The crib having a child monitoring system comprises a crib 11 having a frame with a front wall 12, a rear wall 13, and a pair of sidewalls 14, 15. The frame further includes a horizontal support extending between the walls on which a mattress or pad can be positioned. The frame further includes one or more legs 20 for disposing the crib 11 at an elevated position. Further, the crib 11 has an open upper end and an interior volume defined by the frame. Thus, the construction of the frame of the crib 11 is similar to that of conventional cribs.

The frame includes a child monitoring system including a control circuit that comprises one or more child monitoring devices thereon for allowing a user to remotely monitor a child within the crib 11. A video camera 18 is integrated in a wall of the frame, and in the illustrated embodiment the video camera 18 is integrated into the first sidewall 14 thereof. The video camera 18 is preferably positioned so that the camera is directed towards the interior volume of the crib 11. In this way, the video camera can capture video of the child within the crib 11. The video can be transmitted to a user's mobile electronic device so that the user can remotely view the child within the crib. This would allow a parent to be able to view their child while the parent is at work, running an errand, or is otherwise away from the child.

The child monitoring device may also include a weight sensor. The weight sensor is positioned on the frame and is preferably disposed on the horizontal support. In this way, the weight sensor is positioned underneath a mattress or mattress pad positioned on the horizontal support, and the weight sensor can detect the weight of a child thereon. Thus, the weight sensor is adapted to determine whether an infant is on a mattress and inside of the crib. If the child is removed from the crib 11, the child monitoring system may transmit an alert to the user to notify the user that the child has been removed from the crib. This may alert the user that the child has been kidnapped or that the child has escaped the crib.

The child monitoring device may also include a breathing monitor. The breathing monitor is adapted to determine if the child is breathing properly. This allows the user to quickly determine if the child is having difficulty breathing so that the user can return to the child in order to assist the child. The breathing monitor may include a mat embedded with a plurality of sensors adapted to determine small movements of the infant that are associated with breathing. Alternatively, the breathing monitor may comprise a sensor removably securable to the child for directly measuring the child's breathing. Information or data collected regarding the child's breathing can be transmitted to the user's mobile electronic device via the control unit of the child monitoring system.

The child monitoring system may further comprise additional features such as a nightlight 17 and an audio system. The nightlight 17 is preferably disposed on the exterior of the crib 11 such as on one or more of the walls thereof. In some embodiments, a motion sensor 36 is operably connected to the nightlight 17 so that the nightlight increases in illumination when motion is detected. In this way, a parent can check on the child within the crib 11 during the night and the nightlight will increase in illumination so that the parent can more clearly view the child, but without needing to turn a light on which may disturb or wake the child.

Additionally, the child monitoring system may include an audio system. One or more speakers 19 may be integrated into the frame of the crib 11. The user input device 16 allows a user to select songs or soothing sounds to play for the child. The audio system may be adapted to play for a predetermined period of time and automatically stop playing.

The child monitoring system 11 is preferably operated and controlled by means of a user input device 16. In the illustrated embodiment, the user input device 16 comprises a touchscreen display disposed on the frame of the crib 11. The touchscreen display includes a graphical user interface (GUI) having one or more controls for allowing the user to adjust the settings of the various child monitoring devices and additional features. However, in alternate embodiments, other types of input devices may be used including a plurality of control switches or buttons.

The user input device 16 allows the user to activate or deactivate one or more of the child monitoring devices. For example, the user may wish to deactivate the weight sensor, video camera, and breathing monitor when the user is home and is taking care of the child. Further, the user can use the input device to control the audio system. The user can select a song or sound to play, the user can pause, play or stop the audio, and the user can adjust the volume. In embodiments having a nightlight the user input device 11 allows the user to activate or deactivate the nightlight, and optionally change the color or brightness of the nightlight.

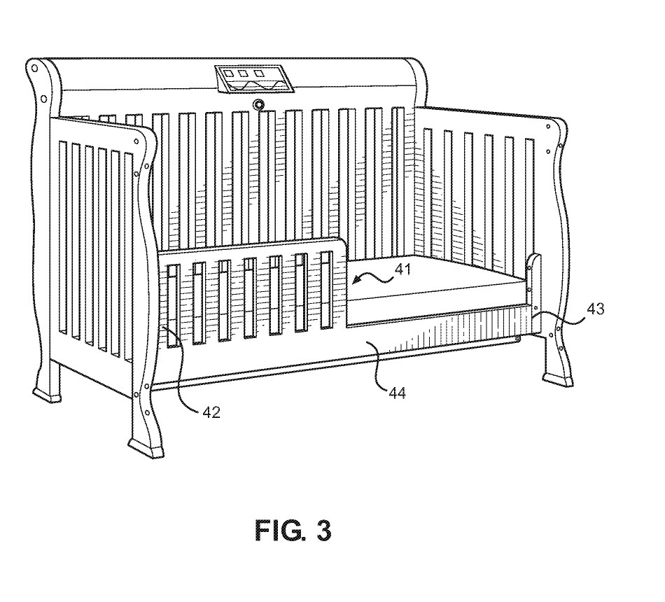

Referring now to FIG. 2, there is shown a perspective view of the base member as positioned for securement to the crib frame. The base member 26 is secured to the crib frame in a horizontal orientation. The base member 26 can support a mattress and mattress pad thereon. Further, in some embodiments, the base member 26 includes a breathing monitor thereon. The upper surface 27 is substantially flat so that a mattress or mattress pad placed thereon can remain in a horizontal orientation.

Opposing ends of the base member 26 comprise outwardly extending tabs 28 adapted to be inserted into one of a plurality of apertures 29 disposed on the legs 20 of the first and second sides of the crib. The first side 14 of the crib comprises a pair of legs 20 each having a plurality of vertically aligned apertures 29 thereon. The tabs 28 can be inserted into a pair of aligned apertures 29 so as to dispose the base member 26 at a desired height. Thus, if the user wishes to dispose the base member 26 at a lower position, the user can insert the tabs 28 into a lower pair of aligned apertures 29 on the legs 20 of the crib rails.

Referring now to FIG. 3, there is shown a perspective view of the crib having a low guard rail. The front crib rail of the crib can be interchanged between a crib rail that is the same height as the side and rear rails of the crib, and a guard rail that is shorter than the side rails and rear rail. The guard rail 41 comprises an elongated member 44 having a first end 42 and a second end 43. The first end 42 includes an upstanding rail section that prevents a child in the crib from exiting the crib. The upstanding rail section is shorter in height than the side rails of the crib. In this way, a guardian can easily reach into the crib to pick up the child within the crib. The second end does not include a rail section and provides access to the interior of the crib.

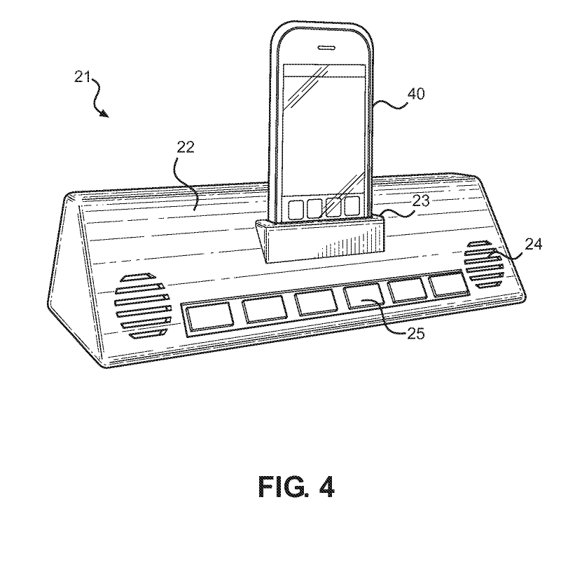

Referring now to FIG. 4, there is shown a perspective view of an embodiment of the docking station of the present invention. In some embodiments, the user input device may comprise a docking station 21. The docking station 21 comprises a housing 22 having an adapter 23 for a portable electronic device, such as a smartphone or tablet, among others. The docking station 21 comprises one or more controls 25 for allowing the user to remotely control the child monitoring system of the crib. Further, the docking station 21 may include one or more speakers 24 for allowing the user to hear the child within the crib.

A mobile device 40 may be engaged with the docking station 21 via the adapter 23 thereon. The user can then use the mobile device 40 to control the operation of the child monitoring system. The mobile device 40 can include a software application that provides a graphical user interface that allows the user to control the child monitoring devices and the additional features such as the nightlight and audio system. The mobile device 40 can receive the audio and video collected by the child monitoring system. The mobile device 40 can also receive the information about the child's breathing collected by the breathing monitor.

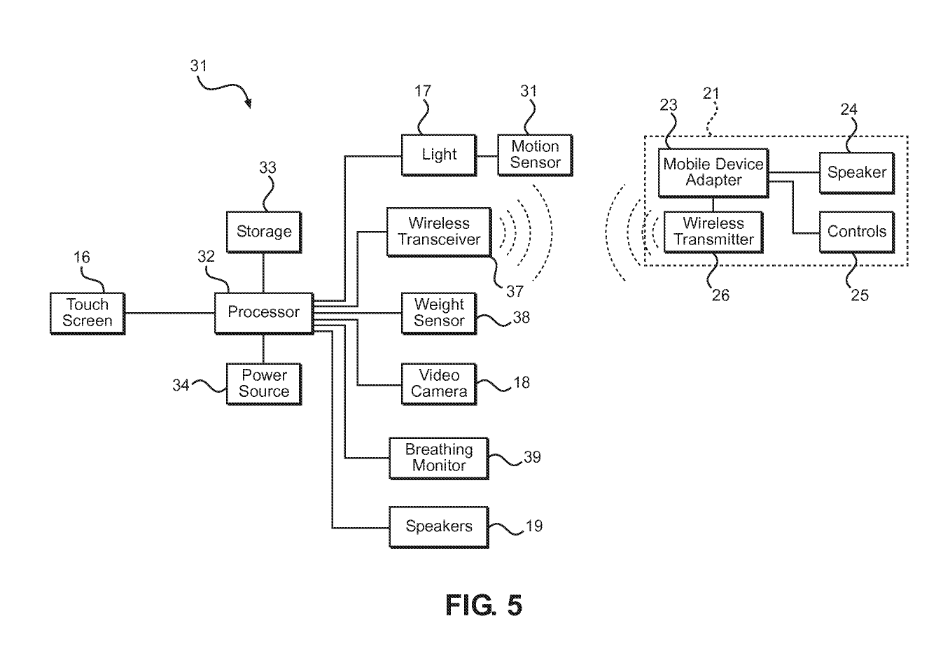

Referring now to FIG. 5, there is shown a schematic diagram of the child monitoring system of the present invention. The control circuit 31 of the child monitoring system comprises a microprocessor 32 having a storage medium 33 and a power source 34. The control circuit 31 further includes a wireless transceiver 37 adapted to allow the child monitoring system to wirelessly communicate with a user's mobile device or with the docking station 21 of the present invention. The control circuit 31 can include a user input device, such as a touchscreen display 16, for allowing the user to control operation of the child monitoring system. Alternatively or additionally, a docking station is provided in which a mobile device can be positioned, wherein the docking station and mobile device can be used to remotely control the operation of the child monitoring system. The docking station 21 comprises an adapter for receiving a mobile device, a wireless transmitter, one or more controls, and one or more speakers.

The control circuit 31 further includes one or more child monitoring devices, such as a weight sensor 38, a video camera 18, and/or a breathing monitor 39. The child monitoring devices can be in wired or wireless connection with the control circuit 31 such that the child monitoring devices can communicate with the control circuit 31. Further, the control circuit 31 may further include a nightlight 17 and motion sensor 36 adapted to control the operation of the nightlight 17. The control circuit 31 is also connected to the audio system which includes one or more speakers 19.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A crib having a child monitoring system, comprising:
a crib having a frame;
a control circuit comprising a microprocessor, a storage medium, a user input device, and one or more monitoring devices integrated into said frame adapted to allow a user to monitor a child within said crib.

2. The crib of claim 1, wherein said one or more monitoring devices comprises a breathing sensor adapted to determine if said child is breathing.

3. The crib of claim 1, wherein said one or more monitoring devices comprises a weight sensor, wherein said weight sensor is positioned on said frame so as to determine if said child is positioned within said crib.

4. The crib of claim 1, wherein said one or more monitoring devices comprises a video camera.

5. The crib of claim 4, wherein said video camera is integrated into said frame of said crib.

6. The crib of claim 1, wherein said user input device comprises a touchscreen display disposed on said frame.

7. The crib of claim 1, wherein said user input device comprises a docking station in wireless communication with said control circuit.

8. The crib of claim 7, wherein said docking station comprises one or more controls so as to allow a user to remotely control said one or more child monitoring devices.

9. The crib of claim 7, wherein said docking station comprises an adapter adapted to receive a mobile electronic device, wherein connection of said mobile electronic device to said docking station enables said mobile electronic device to be used to operate said one or more child monitoring devices.

10. The crib of claim 1, further comprising one or more nightlights thereon.

11. The crib of claim 10, wherein said one or more nightlights are operably connected to a motion sensor such that said one or more nightlights are adapted to illuminate when motion is detected by said motion sensor.

12. The crib of claim 10, wherein said one or more nightlights are operably connected to a motion sensor such that said one or more lights are adapted to increase in illumination when motion is detected.

13. The crib of claim 1, wherein said crib further comprises a base member securable on said frame, wherein said base member comprises one or more tabs;
wherein said frame includes a plurality of apertures thereon adapted to receive said one or more tabs of said base member, such that said base member can be disposed at various heights.

14. The crib of claim 1, wherein said frame comprises a front rail, wherein said front rail is a guard rail comprising an elongated member having a first end and a second end, wherein said first end includes an upstanding rail section.
